(19) United States
(12) Patent Application Publication
(10) Pub. No.: US 2026/0012031 A1
(43) Pub. Date: Jan. 8, 2026

(54) Method, Device, Computer Program, and Computer-Readable Storage Medium for Charging an Energy Storage Device

(71) Applicant: Bayerische Motoren Werke Aktiengesellschaft, Muenchen (DE)

(72) Inventors: Alexander ADAM, Muenchen (DE); Georg BAUER, St. Wolfgang (DE); Johannes WANDT, Muenchen (DE)

(21) Appl. No.: 18/993,624

(22) PCT Filed: Jul. 4, 2023
(86) PCT No.: PCT/EP2023/068381

§ 371 Date: Jan. 13, 2025

(30) Foreign Application Priority Data
Jul. 14, 2022 (DE) 10 2022 117 632.0

(51) Int. Cl. H02J 7/00; B60L 53/62; B60L 53/66; H01M 10/44

(52) U.S. Cl. CPC H02J 7/00712; H01M 10/443; H02J 7/00036; H02J 7/007194; B60L 53/62; B60L 53/66

(57) ABSTRACT

A method for charging an energy storage device includes receiving battery information representing the state of the battery, and ascertaining the state of charge, the cell temperature, and the cell resistance of the energy storage device. On the basis of the battery information, the state of charge, the cell temperature, and the cell resistance of the energy storage device, a charging factor is ascertained. The charging capacity is ascertained on the basis of the charging factor, and the energy storage device is charged using the ascertained charging capacity.

### BACKGROUND AND SUMMARY

The invention relates to a method of charging an energy storage medium. The invention further relates to a device for charging an energy storage medium. The invention further relates to a computer program for charging an energy storage medium. The invention further relates to a computer-readable storage medium on which the computer program is stored.

In modern electrical energy storage media, silicon-containing active materials are frequently used to increase the energy density of the electrical energy storage medium. Frequent charging and discharging, especially fast charging, of the electric energy storage medium result in occurrence of aging effects.

It is an object of the invention to contribute to benign charging of an energy storage medium.

This object is achieved by the features disclosed herein. Advantageous configurations are also identified in the present disclosure.

The invention features a method and a corresponding device for charging an energy storage medium.

In the method, a piece of battery information is received, where the piece of battery information is representative of a state of the battery. In addition, in the method, a load state, a cell temperature and a cell resistance of the energy storage medium are determined. A load factor is determined depending on the piece of battery information, the load state, the cell temperature and the cell resistance of the energy storage medium. A charging power is determined depending on the load factor, and the energy storage medium is charged with the charging power determined.

The energy storage medium is especially an electrical energy storage medium of an electrical vehicle or hybrid vehicle, for example a lithium ion accumulator, comprising a negative electrode, called the “anode”, and a positive electrode, called the “cathode”.

The anode has, for example, an anode active material comprising, for example, a material from the group consisting of carbonaceous materials, silicon, silicon suboxide, silicon alloys, titanium, titanium oxides and mixtures thereof. In particular, the anode active material is selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, titanium, titanium oxides, lithium and mixtures thereof.

In particular, the anode material is an anode material having a silicon content.

The cathode has, for example, a cathode active material. The cathode active material may have a multitude of particles incorporated into an electrode binder. The cathode active material may have a layered oxide, for example a lithium nickel manganese cobalt oxide (NMC), a lithium nickel cobalt aluminum oxide (NCA), a lithium cobalt oxide (LCO) or a lithium nickel cobalt oxide (LNCO). The layered oxide may especially be an overlithiated layered oxide (OLO). Other suitable cathode active materials are compounds having spinel structure, for example lithium manganese oxide (LMO) or lithium manganese nickel oxide (LMNO), or compounds having olivine structure, for example lithium iron phosphate (LFP, LiFePO4) or lithium manganese iron phosphate (LMFP).

The fast charging capacity of lithium ion cells has to date been limited by unwanted side reactions, especially lithium plating at a graphite anode. In order to counteract lithium plating at the graphite anode in a fast charging operation, it is possible, for example, to use step profiles with falling current as the load state increases. However, the silicon content on the anode side alters the fast charging character of the energy storage medium.

The method described enables adjustment of the load profile depending on the piece of battery information, the load state, the cell temperature and the cell resistance of the energy storage medium, which allows benign charging of the energy storage medium.

In an optional configuration, the piece of battery information comprises a piece of information relating to a material composition of electrodes of the energy storage medium and/or to a silicon content of the electrodes of the energy storage medium.

A load profile for benign fast charging of the electrical energy storage medium may be distinctly different depending on the material composition of the electrodes and/or the silicon content of the electrodes. Specifically in the case of anode materials having a silicon content, lowering of the initial charging power may contribute to reducing the aging effects of the electrical energy storage medium.

The method described enables adjustment of the load profile depending on the piece of battery information, especially the piece of information relating to the material composition and/or the silicon content, which allows benign charging of the energy storage medium.

In an optional configuration, the piece of battery information comprises a piece of information relating to a voltage profile of the electrode materials and/or to a voltage range of phase transitions.

A load profile for benign fast charging of the electrical energy storage medium may be distinctly different depending on the voltage profile of the electrode materials and/or the voltage range of phase transitions. Specifically at the phase transitions of the silicon-containing anode material, lowering of the charging power can contribute to reduction of the aging effects of the electrical energy storage medium.

The method described enables adjustment of the load profile depending on the piece of battery information, especially the piece of information relating to the voltage profile of the electrode materials and/or the voltage range of phase transitions of the electrode materials, which allows benign charging of the energy storage medium.

In an optional configuration, the charging power is determined depending on one or more charging parameters, comprising a planned charging time and/or an amount of energy to be charged.

By virtue of the determination of the charging power depending on one or more load parameters, the necessary charging power and the necessary charging time for the charging from a first load state up to a second load state are determined.

The reference charging power determined depending on one or more charging parameters serves here as a reference for further adjustment of the charging power via the load factor.

In an optional configuration, the energy storage medium is charged such that the charging power, in a first load state range, is adjusted by a first load factor up to a first load state and is adjusted by a second load factor in a second load state range between the first load state and a second load state, where the charging power in the first load state range and the second load state range is different.

Depending on the piece of battery information, the load state, the cell temperature and the cell resistance of the energy storage medium, it may be advisable to divide the charging power into multiple load state ranges depending on the load factor, where a load factor is determined for each load state range in order to charge the energy storage medium in a benign manner.

For example, the energy storage medium, on the basis of the piece of battery information, the load state, the cell temperature and the cell resistance of the energy storage medium, comprises two load state ranges at a current load state of 20%. The first load state range lies between the current load state of 20% and a load state of 30%, and the second load state range lies between 30% and 100%.

In order to conserve the silicon-containing anode, the energy storage medium is charged in the first load state range, for example, at a C rate of 1 C, and in the second load state range, for example, at a C rate of 3 C.

In an optional configuration, in the determination of the load factor, a weighting is assigned to the piece of battery information, to the load state, to the cell temperature and to the cell resistance.

The weighting can ensure that safety-critical parameters, for example the cell temperature, have a much greater influence on the load factor and hence the charging performance is adjusted to a greater degree.

In an optional configuration, the load factor is also ascertained depending on a cell voltage of the energy storage medium.

By ascertaining the load factor also depending on a cell voltage of the energy storage medium, it can be ensured that the cell voltage limits the charging power for charging of the energy storage medium.

The invention further features a computer program for charging of an energy storage medium, comprising commands which, when the computer program is executed by a computer, cause it to execute the method of charging an energy storage medium.

The invention also features a computer-readable storage medium on which the computer program is stored.

The computer-readable storage medium especially comprises a medium readable by a data processing device, on which program code is stored.

Working examples of the invention are elucidated in detail hereinafter with reference to schematic diagrams.

### BRIEF DESCRIPTION OF THE DRAWINGS

FIG. 1 a flow diagram of a program for charging an energy storage medium,

FIG. 2 a diagram with a stepped load profile,

FIG. 3 a diagram with a load profile with charging power initially increasing in a linear manner, and

FIG. 4 a diagram with a load profile with charging power initially increasing in a stepwise manner.

### DETAILED DESCRIPTION OF THE DRAWINGS

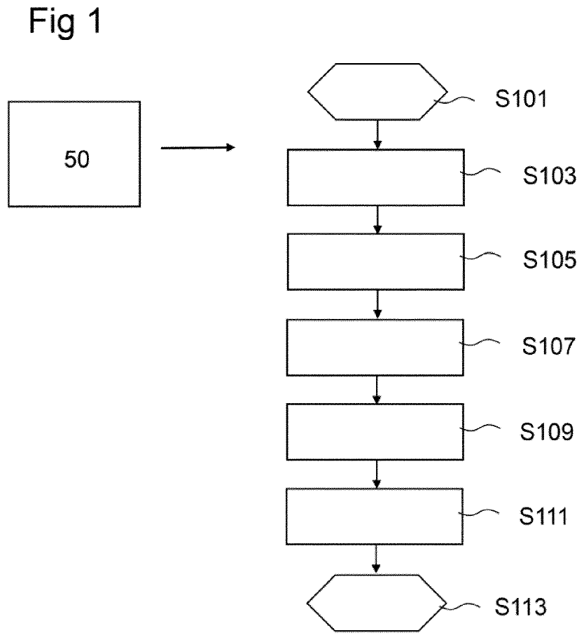

FIG. 1 shows a flow diagram of a program for charging an energy storage medium.

A device 50 is designed to run the program. For this purpose, the device 50 has in particular a computation unit, a program and data storage memory, and, for example, one or more communication interfaces. The program and data storage memory and/or the computation unit and/or the communication interfaces may be designed in one component and/or distributed between two or more components.

The device 50 may also be referred to as a device for charging an energy storage medium.

For this purpose, in particular, the program is stored on the program and data storage memory of the device 50.

The program is started in a step S101 in which variables may optionally be initialized.

In a step S103, a piece of battery information is received. The piece of battery information is representative of a state of the battery.

For example, the piece of battery information is stored in a battery management system.

The piece of battery information comprises, for example, a piece of information relating to a material composition of the electrodes of the battery and/or to a silicon content of the electrodes of the energy storage medium and/or to a voltage profile of the electrode materials and/or to a voltage range of phase transitions of the electrode materials.

The piece of information relating to a material composition of the electrodes and/or to a silicon content of the electrodes of the battery comprises, for example, a piece of information relating to the electrode material of the anode used, for example a silicon oxide-containing material having a silicon content at the active material of the anode of 20%.

The piece of information relating to a voltage profile of the electrode materials and/or to a voltage range of phase transitions of the electrode materials comprises, for example, a piece of information relating to a voltage range of the anode material and/or a voltage range of a phase transition of the anode material during a charging operation, for example a voltage range of the cathode voltage and full-cell voltage of 3.0 V to 4.2 V and a voltage range of the anode voltage of 0.05 V to 1.5 V.

In a step S105, a load state, a cell temperature and a cell resistance of the energy storage medium are determined.

For example, the cell temperature at a cell housing is determined by temperature sensors. For example, the load state of the energy storage medium is determined via the open-circuit voltage of the energy storage medium. For example, the energy storage medium has means of ascertaining the cell resistance.

In a step S107, a load factor is determined depending on the piece of battery information, the load state, the cell temperature and the cell resistance of the energy storage medium.

Recorded in the device 50, for example, are look-up tables relating to the piece of battery information, the load state, the cell temperature and the cell resistance of the energy storage medium and/or a basis for calculation of the load factor based on the piece of battery information, the load state, the cell temperature and the cell resistance of the energy storage medium, by which the load factor is determined.

For example, the load factor is reduced as soon as the temperature goes above a temperature threshold value, 40° C. here for example. With increasing temperature above the temperature threshold value, the load factor is reduced continuously, for example.

For example, the load factor is reduced depending on the piece of battery information and the load state when the piece of battery information contains a piece of information about an existing silicon content in the anode active material and the load state is below a load state threshold value, 30% here for example. For example, the load factor is increased as soon as a load state above the load state threshold value is attained.

For example, the load factor is reduced as soon as the cell resistance goes above a cell resistance threshold value. With increasing cell resistance above the cell resistance threshold value, the load factor is reduced continuously, for example.

In determining a load factor, a weighting is assigned to the piece of battery information, the load state, the cell temperature and the cell resistance. For example, the cell temperature is assigned a higher weighting than the cell resistance. For example, the cell temperature parameter has double weighting in the determination of the load factor, and the parameters of the piece of battery information, load state and cell resistance each have single weighting.

The load factor is additionally determined depending on a cell voltage of the energy storage medium.

In a step S109, a charging power is determined depending on the load factor.

The charging power is determined here depending on one or more charging parameters. The charging parameters comprise a planned charging time and/or an amount of energy to be charged.

For example, the energy storage medium is to be charged from a load state of 20% to a load state of 80% within a charging time of 20 minutes.

The charging power is determined depending on the load factor such that the charging power, in a first load state range, is adjusted by a first load factor up to a first load state and is adjusted by a second load factor in a second load state range between the first load state and a second load state, where the charging power in the first range and the second range is different.

In a step S111, the energy storage medium is charged with the charging power determined.

The energy storage medium is, for example, an energy storage medium having an anode including silicon oxide and silicon, especially with a silicon content of about 20%. Alternatively, the anode may include, for example, graphite and silicon oxide as active materials, especially with a silicon oxide content of about 20%.

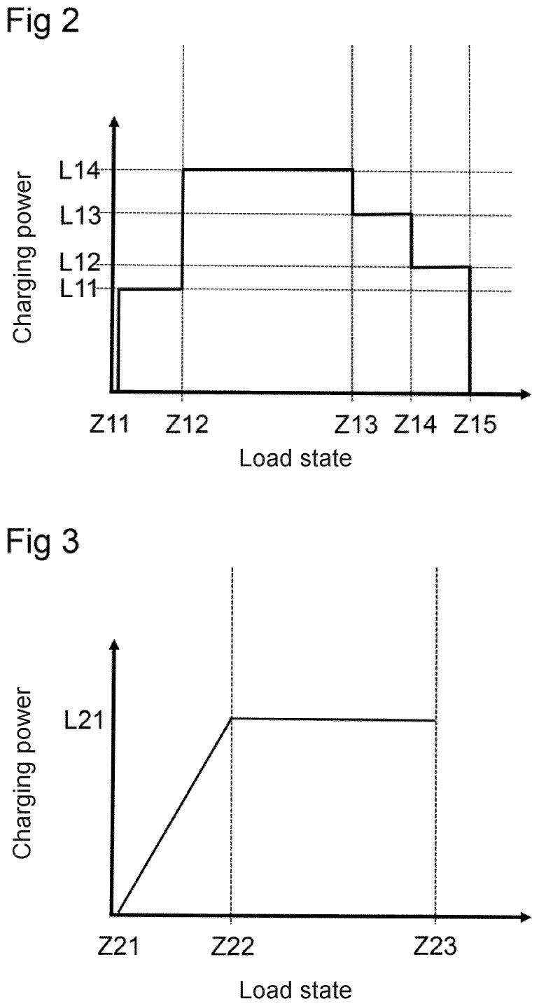

In a first example, the energy storage medium can be charged in the example from FIG. 2 according to the diagram with a stepped load profile.

For example, the energy storage medium is charged from an original load state Z11, 20% for example here, to a final load state Z15, 80% for example here. On the basis of the piece of battery information relating to the silicon content of the silicon oxide anode and the load state of 20%, for example, a load factor is determined, according to which the energy storage medium is charged with a charging power L11, 0.8 C for example here, since the silicon undergoes significant aging effects at high charging currents owing to intrinsic material properties in low load state ranges.

At a load state Z12, 30% for example here, a load factor is determined, according to which the energy storage medium is charged with a charging power L14, 2 C for example here, up to a load state Z13, 60% for example here.

For example, the load factor is then determined again at a load state of 60% such that the charging power is reduced between load state Z13 and Z14, 70% for example here, to a charging power L13, 1.5 C for example here.

For example, the load factor is then determined again at a load state of 70% such that the charging power is reduced between load state Z14 and Z15, between 70% and 80%, to a charging power L12, 1 C for example here.

In a second example, the energy storage medium in the example from FIG. 3 can be charged according to the diagram with a load profile with charging power initially increasing in a linear manner.

For example, the load factor is determined continuously, which means that the charging power is increased continuously depending on the load factor from a first load state Z21, 20% for example here, up to a second load state Z22, 30% for example here, and the energy storage medium is charged from the load state Z22 at a constant charging power L21, 1.5 C for example here, up to a load state Z23, 80% for example here.

In a step S113, the program is ended and can optionally be restarted again.

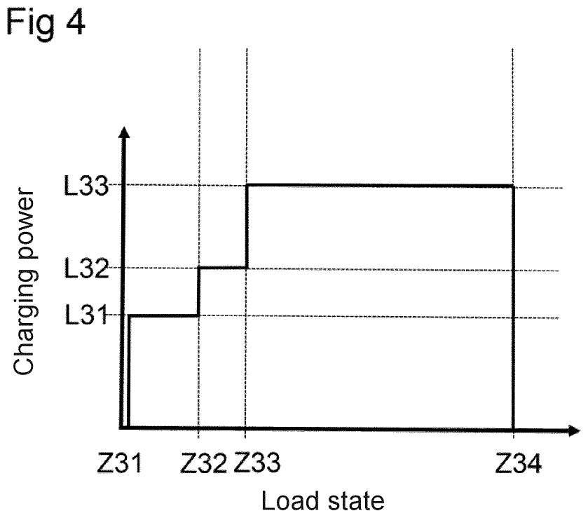

In a third example, the energy storage medium in the example from FIG. 4 can be charged according to the diagram with a charging profile with charging power initially increasing in a stepwise manner.

For example, the energy storage medium is charged from an original load state Z31, 20% for example here, to a final load state Z34, 80% for example here. On the basis of the piece of battery information with regard to the silicon content of the silicon oxide anode and the load state of 20%, for example, a load factor is ascertained, by which the energy storage medium is charged with a charging power L31, 0.8 C for example here, since the silicon undergoes significant aging effects at high charging currents owing to intrinsic material properties in low load state ranges.

At a load state Z32, 30% for example here, a load factor is ascertained, by which the energy storage medium is charged with a charging power L32, 1 C for example here, up to a load state Z33, 40% for example here.

For example, the load factor is then determined again at the load state Z33 such that the charging power is increased between load state Z33 and Z34 to a charging power L33, 2 C for example here.

### LIST OF REFERENCE NUMERALS

S1-S9 steps
50 device
Z11-Z15; Z21-Z23; Z31-Z34 load states
L11-L14; L21; L31-L33 charging powers

1-10. (canceled)

11. A method of charging an energy storage medium, comprising:
receiving a piece of battery information, where the piece of battery information is representative of a state of the battery;
determining a load state, a cell temperature, and a cell resistance of the energy storage medium;
determining a load factor depending on the piece of battery information, the load state, the cell temperature, and the cell resistance of the energy storage medium;
determining a charging power depending on the load factor; and
charging the energy storage medium with the determined charging power.

12. The method according to claim 11,
wherein the piece of battery information comprises a piece of information relating to a material composition of electrodes of the energy storage medium and/or to a silicon content of the electrodes of the energy storage medium.

13. The method according to claim 11,
wherein the piece of battery information comprises a piece of information relating to a voltage profile of the electrode materials and/or to a voltage range of phase transitions of the electrode materials.

14. The method according to claim 11, comprising:
determining the charging power depending on one or more charging parameters including a planned charging time and/or an amount of energy to be charged.

15. The method according to claim 11, comprising:
charging the energy storage medium such that the charging power, in a first load state range, is adjusted by a first load factor up to a first load state, and is adjusted by a second load factor in a second load state range between the first load state and a second load state, wherein the charging power in the first range and the second range is different.

16. The method according to claim 11, comprising:
in the determining of the load factor, assigning a weighting to the piece of battery information, to the load state, to the cell temperature, and to the cell resistance.

17. The method according to claim 11, comprising:
determining the load factor also as a function of a cell voltage of the energy storage medium.

18. A device for charging an energy storage medium, wherein the device is configured to:
receive a piece of battery information, where the piece of battery information is representative of a state of the battery;
determine a load state, a cell temperature, and a cell resistance of the energy storage medium;
determine a load factor depending on the piece of battery information, the load state, the cell temperature, and the cell resistance of the energy storage medium;
determine a charging power depending on the load factor; and
charge the energy storage medium with the determined charging power.

19. The device according to claim 18,
wherein the piece of battery information comprises a piece of information relating to a material composition of electrodes of the energy storage medium and/or to a silicon content of the electrodes of the energy storage medium.

20. The device according to claim 18,
wherein the piece of battery information comprises a piece of information relating to a voltage profile of the electrode materials and/or to a voltage range of phase transitions of the electrode materials.

21. The device according to claim 18, wherein the device is configured to:
determine the charging power depending on one or more charging parameters including a planned charging time and/or an amount of energy to be charged.

22. The device according to claim 18, wherein the device is configured to:
charge the energy storage medium such that the charging power, in a first load state range, is adjusted by a first load factor up to a first load state, and is adjusted by a second load factor in a second load state range between the first load state and a second load state, wherein the charging power in the first range and the second range is different.

23. The device according to claim 18, wherein the device is configured to:
when determining the load factor, assign a weighting to the piece of battery information, to the load state, to the cell temperature, and to the cell resistance.

24. The device according to claim 18, wherein the device is configured to:
determine the load factor also as a function of a cell voltage of the energy storage medium.

25. A non-transitory computer-readable medium having stored thereon a program for charging an energy storage medium, comprising commands which, when executed by a computer, cause the computer to execute a method comprising:
receiving a piece of battery information, where the piece of battery information is representative of a state of the battery;
determining a load state, a cell temperature, and a cell resistance of the energy storage medium;
determining a load factor depending on the piece of battery information, the load state, the cell temperature, and the cell resistance of the energy storage medium;
determining a charging power depending on the load factor; and
charging the energy storage medium with the determined charging power.

26. The non-transitory computer-readable medium according to claim 25,
wherein the piece of battery information comprises a piece of information relating to a material composition of electrodes of the energy storage medium and/or to a silicon content of the electrodes of the energy storage medium.

27. The non-transitory computer-readable medium according to claim 25,
wherein the piece of battery information comprises a piece of information relating to a voltage profile of the electrode materials and/or to a voltage range of phase transitions of the electrode materials.

28. The non-transitory computer-readable medium according to claim 25, wherein the method comprises:
determining the charging power depending on one or more charging parameters including a planned charging time and/or an amount of energy to be charged.

29. The non-transitory computer-readable medium according to claim 25, wherein the method comprises:
charging the energy storage medium such that the charging power, in a first load state range, is adjusted by a first load factor up to a first load state, and is adjusted by a second load factor in a second load state range between the first load state and a second load state, wherein the charging power in the first range and the second range is different.

30. The non-transitory computer-readable medium according to claim 25, wherein the method comprises:
in the determining of the load factor, assigning a weighting to the piece of battery information, to the load state, to the cell temperature, and to the cell resistance.
